(19) United States
(12) Patent Application Publication
(10) Pub. No.: US 2024/0298051 A1
(43) Pub. Date: Sep. 5, 2024

(54) DATA RELAY APPARATUS, DISTRIBUTION SYSTEM, DATA RELAY METHOD, AND COMPUTER-READABLE MEDIUM

(71) Applicant: NEC Corporation, Minato-ku, Tokyo (JP)

(72) Inventor: Tamotsu Mukaiyachi, Tokyo (JP)

(73) Assignee: NEC Corporation, Minato-ku, Tokyo (JP)

(21) Appl. No.: 18/573,063

(22) PCT Filed: Jun. 29, 2021
(86) PCT No.: PCT/JP2021/024478

§ 371 Date: Dec. 21, 2023

(51) Int. Cl. H04N 21/2387; H04N 21/222

(52) U.S. Cl. CPC H04N 21/2387; H04N 21/222

(57) ABSTRACT

The present disclosure relates to a data relay apparatus (30B) arranged between a CL(10) and an OS(20) which distributes video data; the data relay apparatus transmits video data distributed from the OS(20) to the CL(10). The data relay apparatus (30B) of the present disclosure includes a first determination unit (311) which receives uploaded data to be transmitted from the CL(10) to the OS(20) and determines whether or not the uploaded data is specified uploaded data based on the data size of the uploaded data, and a second determination unit (312) which determines whether or not accelerated playback of the video data is being performed in the CL(10) based on the transmission interval of the specified uploaded data.

### TECHNICAL FIELD

The present disclosure relates to a data relay apparatus, distribution system, data relay method, and computer-readable medium.

### BACKGROUND ART

Recently, an increasing number of video distribution websites have adopted adaptive bitrate (hereinafter referred to as ABR) as a video distribution system. ABR is a video distribution technology that enables smooth playback of video data at the highest possible image quality in accordance with a viewing environment. There is a plurality of standards of video distribution. Typical standards include, for example, HLS (HTTP (Hypertext Transfer Protocol) Live Streaming) and MPEG-DASH (Moving Picture Experts Group-Dynamic Adaptive Streaming over HTTP).

ABR automatically changes the image quality of video data according to the processing capacity, resolution, line speed, etc. of a client terminal (Client: hereinafter referred to as CL) such as mobile phones, and enables comfortable viewing of video data on the CL. To dynamically change the image quality of video data, the video data is divided into segments every few seconds to several tens of seconds, and video data with various image qualities is prepared in advance in a distribution server (Origin Server: hereinafter referred to as OS). The CL selects a segment to be obtained and the image quality depending on the viewing environment, and requests the video data from the OS. The HTTP protocol is used when the CL requests the video data from the OS. The CL specifies the segment and image quality of the request data (HTTP request packet) with the HTTP protocol, transmits the request data to the OS, and obtains the video data as response data from the OS.

FIG. 1 shows an example of a time change in the image quality of the video data of the ABR. In FIG. 1, the horizontal axis represents time, and the vertical axis represents the image quality of the video data. As shown in FIG. 1, the CL selects a segment with the image quality of 1080p during 00:00˜00:10, a segment with the image quality of 480p during 00:10˜00:20, and a segment with the image quality of 720p during 00:20˜00:30 and 00:30˜00:40.

The distribution of ABR video data is roughly divided into two phases. One is a buffering phase and the other is a steady phase (FIG. 2). FIG. 2 shows an example of a time-series change in the amount of data that the CL receives from the OS. In FIG. 2, the horizontal axis represents time, and the vertical axis represents the amount of data.

In the buffering phase, the state of the network between the CL and the OS is observed, and appropriate image quality and sound quality of video are determined in accordance with the viewing environment. In addition, in order to buffer video data enough to start playback of video data at the CL side, the OS transmits video data in a burst manner.

In the steady phase, after the image quality of video and the sound quality of sound are determined in the buffering phase, the CL obtains divided video data (segments) from the OS at specific intervals so that the video data buffered on the CL does not run out according to the progress of the playback of the video data.

As shown in FIG. 2, when the playback of the video data starts in the CL, the buffering phase comes first, and then the steady phase comes next. In some cases, after the steady phase comes, then the buffering phase comes again. This repeat of buffering is called rebuffering. For example, if the state of the network changes and the image quality is changed by the ABR mechanism, the CL needs to download the video data again to cause rebuffering. What causes rebuffering on the CL side is called a rebuffering event.

In recent years, the variety of genres of video content on video distribution sites has been increasing, and the number of video contents of business and education as well as entertainment has been increasing. In order to meet the needs of users who want to watch videos efficiently with shorter time, the number of video distribution sites that support accelerated playback, which speeds up the playback speed of video data, has been increasing.

On the other hand, with the increase in video traffic in recent years, in order to reduce communication bandwidth by reducing redundant traffic, it is known that a related technology for performing traffic optimization processing for controlling the transmission bitrate of video data in a data relay apparatus between the CL and the OS (see, for example, Patent Document 1.).

In traffic optimization, there is also a technology for the ABR video data distribution. For example, in a data relay apparatus, when the transmission bitrate of the ABR video data to be transmitted to the CL is controlled, the image quality corresponding to the transmission bitrate is selected in the CL by the ABR mechanism. In this manner, the image quality of the video data distributed from the OS to the CL is changed.

If the image quality of the video data is high, the amount of data is large, and if the image quality of the video data is low, the amount of data is small. Therefore, by controlling the transmission bitrate of the video data of ABR, the image quality of the video data is controlled, and the amount of the video data flowing on the network is also controlled.

FIG. 3 shows a sequence diagram for explaining an example of traffic optimization of video data of ABR by the data relay apparatus. As shown in FIG. 3, the CL10 transmits request data (request data with HTTP protocol with the specified image quality, segments, etc.) requesting video data to the OS20 (Step S11). A data relay apparatus 30 transfers the request data from the CL10 to the OS20 (Step S12).

The OS20 transmits the video data (a segment with the specified image quality) requested from the CL10 to the CL10 as response data (Step S13). The data relay apparatus 30 transmits the video data to the CL10 while controlling the transmission bitrate of the video data from the OS20 (Step S14). For example, when the network is congested, the transmission bitrate of the video data transmitted from the data relay apparatus 30 to the CL10 is lowered, and the low image quality video data is selected by the CL10 according to the ABR mechanism. Thus, the data amount of the video data distributed from the OS20 is reduced to alleviate the congestion of the network. This control of the transmission bitrate is referred to as pacing, shaping, or throttling, and hereinafter referred to as pacing.

The CL10 selects the image quality corresponding to the transmission bitrate of the video data in Step S14 according to the ABR mechanism. Here, it is assumed that the CL10 selects a lower image quality (smaller data amount). In this case, the CL10 transmits request data requesting video data with a lower image quality to the OS20 (Step S15), and the data relay apparatus 30 transfers request data from the CL10 to the OS20 (Step S16).

The OS20 transmits the video data with the lower image quality requested from the CL10 to the CL10 as response data (Step S17). The data relay apparatus 30 transmits the video data with the lower image quality from the OS20 to the CL10 (step S18). As a result, the image quality of the video data distributed from the OS20 to the CL10 changes to the lower image quality.

### CITATION LIST

### Patent Literature

[Patent Literature 1] International Patent Publication No. WO 2016/185998

### SUMMARY OF INVENTION

### Technical Problem

In the pacing process shown in FIG. 3, the transmission bitrate is determined in accordance with the target image quality of the video data. However, when the video data is played using accelerated playback by the CL10, the downloading (download; hereinafter referred to as DL) speed of the video data is increased even with the same image quality.

FIG. 4 shows an example of the current transmission bitrate of the video data transmitted from the data relay apparatus 30 to the CL10 during pacing. In FIG. 4, the horizontal axis represents time, and the vertical axis represents the transmission bitrate of the video data.

As shown in FIG. 4, it is assumed that the data relay apparatus 30 performs pacing at the same transmission bitrate (normal distribution rate in FIG. 4) even when the video data is played using accelerated playback with the same image quality in the CL10. In this case, the transmission bitrate from the data relay apparatus 30 is lower than the distribution rate required when the video data is played using accelerated playback, so that the transmission bitrate is insufficient. As a result, the CL10 cannot perform the DL quickly enough, and the playback of the video data is stopped and the image quality is degraded, thereby the quality of experience (QoE) that of users becomes poor.

Therefore, in order to optimize traffic while preventing the deterioration of QoE, the data relay apparatus 30 determines whether or not the video data is being played using accelerated playback in the CL10, and if it is played using accelerated playback, it is necessary to change the transmission bitrate of the video data to be transmitted to the CL10.

FIG. 5 shows an example of an ideal transmission bitrate of the video data to be transmitted from the data relay apparatus 30 to the CL10 during pacing. In FIG. 5, the horizontal and vertical axes represent the same as those in FIG. 4.

As shown in FIG. 5, when the CL10 determines that the video data is being played using accelerated playback, the data relay apparatus 30 increases the transmission bitrate of the video data to be transmitted to the CL10. As a result, since the CL10 can perform the DL quickly enough to play using accelerated playback, it is possible to optimize the traffic while preventing the deterioration of QoE.

However, it is difficult for the data relay apparatus 30 to determine whether or not the video data is being played using accelerated playback in the CL10. The reason is that video data in recent years is encrypted by, for example, TLS (Transport Layer Security), and the data relay apparatus 30 cannot refer to the contents of the video data (metadata such as header information or the video data itself). At present, the data relay apparatus 30 can obtain only the data size and flow rate (bitrate) of the uploaded data transmitted from the CL10 to the OS20 and the response data (video data) transmitted from the OS20 to the CL10. It is difficult for the data relay apparatus 30 to determine the accelerated playback from this limited information.

Therefore, it is an object of the present disclosure to provide a data relay apparatus, a distribution system, a data relay method, and a computer-readable medium that can solve the problems described above and determine by the data relay apparatus whether or not video data is being played using accelerated playback in a client terminal.

### Solution to Problem

A data relay apparatus arranged between a client terminal and a distribution server for distributing video data and configured to transmit the video data distributed from the distribution server to the client terminal includes: a first determination unit configured to receive uploaded data to be transmitted from the client terminal to the distribution server and determine whether or not the uploaded data is specified uploaded data based on a data size of the uploaded data; and a second determination unit configured to determine whether or not accelerated playback of the video data is being performed at the client terminal based on a transmission interval of the determined specified uploaded data.

A distribution system includes: a client terminal; a distribution server configured to distribute video data; and the data relay apparatus.

A data relay method performed by a data relay apparatus arranged between a client terminal and a distribution server for distributing video data and configured to transmit video data distributed from the distribution server to the client terminal includes: a receiving step of receiving uploaded data to be transmitted from the client terminal to the distribution server: a first determination step of determining whether or not the uploaded data is specified uploaded data based on a data size of the uploaded data; and a second determination step of determining whether or not accelerated playback of the video data is being performed at the client terminal based on a transmission interval of the determined specified uploaded data.

A non-temporary computer-readable medium stores a program for causing a computer, which is arranged between a client terminal and a distribution server for distributing video data and configured to transmit video data distributed from the distribution server to the client terminal, to execute: a receiving process for receiving uploaded data to be transmitted from the client terminal to the distribution server: a first determination process for determining whether or not the uploaded data is specified uploaded data based on a data size of the uploaded data; and a second determination process for determining whether or not accelerated playback of the video data is being performed at the client terminal based on a transmission interval of the determined specified uploaded data.

### Advantageous Effects of Invention

According to the above-described aspect, the data relay apparatus which can determine whether or not video data is being played using accelerated playback, a distribution system whose data relay apparatus can determine whether or not video data is being played using accelerated playback, a data relay method whose data relay apparatus can determine whether or not video data is being played using accelerated playback, and a computer-readable medium whose data relay apparatus can determine whether or not video data is being played using accelerated playback can be provided.

### BRIEF DESCRIPTION OF DRAWINGS

FIG. 1 is a diagram for explaining an example of a time change in the image quality of video data of ABR.

FIG. 2 is a diagram for explaining an example of a time-series change in the amount of data which the CL receives from the OS.

FIG. 3 is a sequence diagram for explaining an example of traffic optimization of video data of ABR by a data relay apparatus.

FIG. 4 is a diagram for explaining an example of the current transmission bitrate of video data to be transmitted from the data relay apparatus to the CL during pacing.

FIG. 5 is a diagram for explaining an example of an ideal transmission bitrate of video data to be transmitted from the data relay apparatus to the CL during pacing.

FIG. 6 is a diagram for explaining an example of the data relay apparatus terminating TCP/UDP communication.

FIG. 7 is a diagram for explaining an example of the data relay apparatus not terminating TCP/UDP communication.

FIG. 8 is a sequence diagram for explaining an example of a sequence during transmission and reception of video data between the CL and the OS.

FIG. 9 is a diagram for explaining an example of a protocol stack of video data of the ABR.

FIG. 10 is a diagram for explaining an example of a graph in which request data from the CL is observed when the same video data of the same image quality is played at different playback speed on the CL.

FIG. 11 is a diagram for explaining an example of a graph in which request data from the CL is observed when the same video data of the same image quality is played at different playback speed on the CL.

FIG. 12 is a diagram for explaining an example of a graph in which request data from the CL is observed when the same video data of the same image quality is played at different playback speed on the CL.

FIG. 13 is a block diagram showing an example of a configuration of the data relay apparatus according to a first example embodiment.

FIG. 14 is a diagram explaining an operation example of the data relay apparatus according to the first example embodiment.

FIG. 15 is a flow diagram explaining an operation example of the data relay apparatus according to the first example embodiment.

FIG. 16 is a block diagram showing a configuration example of the data relay apparatus according to a second example embodiment.

FIG. 17 is a block diagram showing a hardware configuration example of the data relay apparatus according to a third example embodiment.

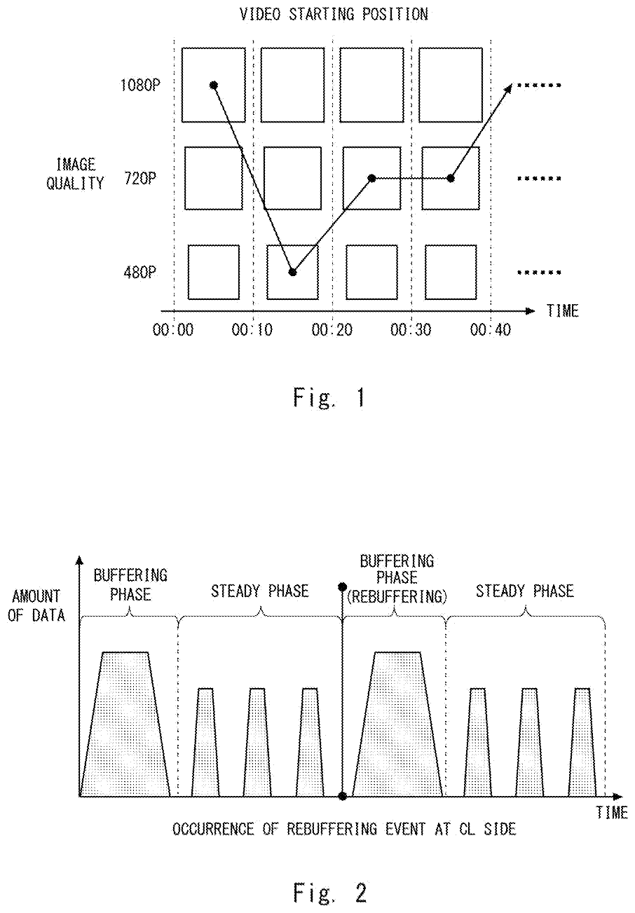

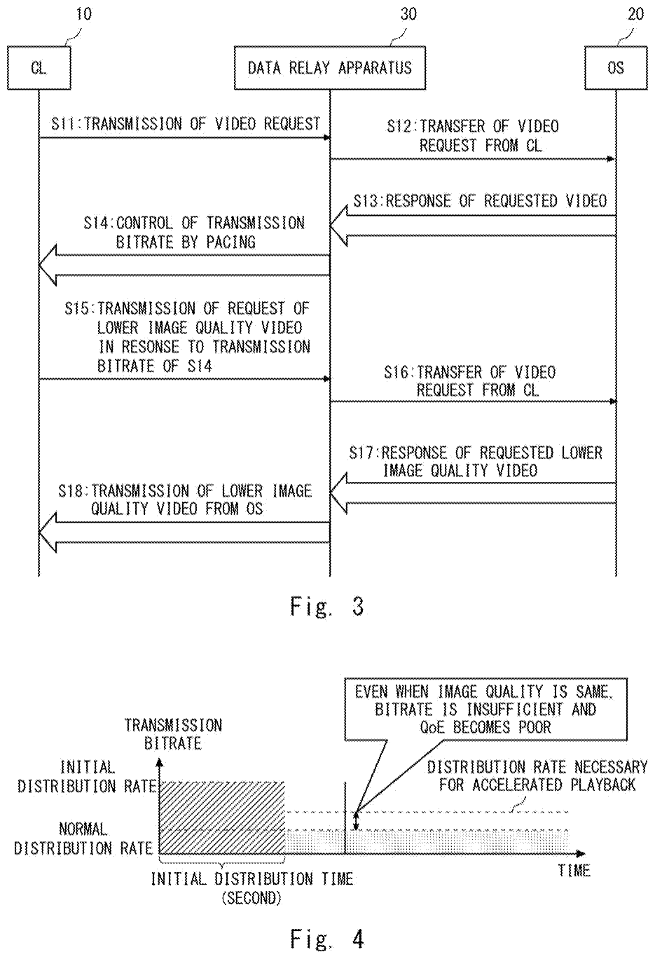

### EXAMPLE EMBODIMENT

Hereinafter, an outline of the present disclosure and an example embodiment will be described with reference to the drawings. The following descriptions and drawings have been omitted and simplified as appropriate for clarity of explanation. In the following drawings, the same elements have the same reference numerals, and duplicate explanations have been omitted as necessary.

Before describing example embodiments of the present disclosure, an outline of the present disclosure will be described.

### <Outline of the Present Disclosure>

In the present disclosure, a method is proposed by which a data relay apparatus 30A according to the present disclosure determines whether or not accelerated playback of ABR video data is being performed in the CL10 by analyzing the data size and transmission intervals of the uploaded data to be transmitted from the CL10 to the OS20. Here, the data size and transmission intervals of the uploaded data are information that can be obtained by the data relay apparatus 30A.

The method to be proposed is effective regardless of whether video data of the ABR is encrypted or not, because accelerated playback is determined with the information that can be obtained by the data relay apparatus 30A. The method to be proposed is effective not only for TCP (Transmission Control Protocol) but also for UDP (User Datagram Protocol) (e.g. QUIC (Quick UDP Internet Connections)) as a video protocol. Furthermore, the method to be proposed is effective regardless of whether TCP/UDP communication is terminated by the data relay apparatus 30A.

FIG. 6 shows an image example when the data relay apparatus 30A terminates TCP/UDP communication. As shown in FIG. 6, when the data relay apparatus 30A terminates TCP/UDP communication, communication is performed in separate TCP sessions between the CL10 and the data relay apparatus 30A, and between the data relay apparatus 30A and the OS20. That is, when the data relay apparatus 30A communicates with the CL10 and the OS20, the data relay apparatus 30A generates TCP sessions for each of them.

On the other hand, FIG. 7 shows an image example when the data relay apparatus 30A does not terminate TCP/UDP communication. As shown in FIG. 7, when the data relay apparatus 30A does not terminate TCP/UDP communication, the CL10 exchanges data with the OS20 in a direct TCP session, and the data relay apparatus 30A only transfers data. That is, the CL10 and the OS20 communicate directly in one TCP session, and the data relay apparatus 30A transfers data.

The method to be proposed will be described below. During the playback of ABR video data, the uploaded data transmitted from the CL10 to the OS20 can be roughly divided into two types. One is request data (HTTP request packet) requesting video data, and the other is acknowledgement data (ACK (ACKnowledgement) packet) notifying that the video data has been received.

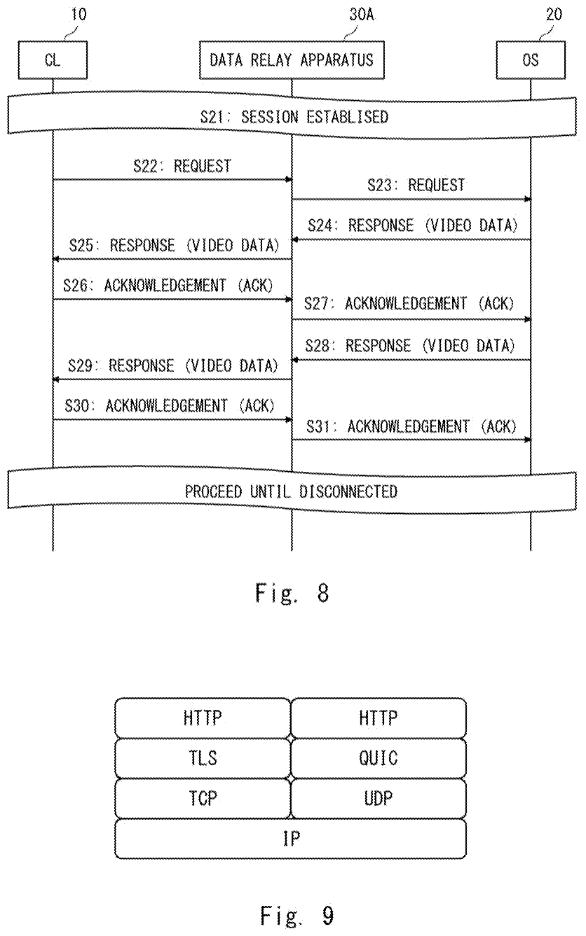

FIG. 8 shows a sequence of video data transmission and reception between the CL10 and the OS20. As shown in FIG. 8, firstly, a session is established between the CL10 and the OS20 via the data relay apparatus 30A (Step S21).

Next, the CL10 transmits request data (HTTP request packet) requesting the video data to be obtained to the OS20 (Step S22). Next, the data relay apparatus 30A transfers the request data from the CL10 to the OS20 (Step S23).

When the OS20 receives the request data from the CL10 via the data relay apparatus 30A, the OS20 transmits the video data requested from the CL10 to the CL10 as response data (HTTP response) to the request data (Step S24). Next, the data relay apparatus 30A transfers the video data from the OS20 to the CL10 (Step S25).

When the CL10 receives the video data from the OS20 via the data relay apparatus 30A, the CL10 transmits the acknowledgement data (ACK packet) to the OS20 in order to notify that the video data has been received (Step S26). Next, the data relay apparatus 30A transfers the acknowledgement data from the CL10 to the OS20 (Step S27). Thereafter, Steps S28 to S31 similar to Steps S24 to S27 are continuously performed until the session is disconnected.

As shown in FIG. 8, the OS20 receives the acknowledgement data from the CL10 via the data relay apparatus 30A, thereby confirming that the video data has been transmitted to the CL10. This operation is an operation for ensuring the reliability of TCP communication. This operation is performed not only for TCP/IP (Internet Protocol) communication but also for QUIC traffic running on the UDP/IP protocol stack, which has been increasing in recent years.

FIG. 9 shows an example of a protocol stack of ABR video data. As shown in FIG. 9, the QUIC protocol uses UDP rather than TCP. However, the QUIC protocol provides functions such as retransmission control, congestion control, and loss recovery, which are equivalent to the functions of TCP, in order to ensure the reliability of communication, and acknowledgment data (ACK packets) is transmitted in the same manner as TCP.

Typical ABR standards (such as HSL and MPEG-DASH) use the HTTP protocol to control the acquisition and distribution of video. The data size of request data (HTTP request packets) by ABR is relatively large. However, the data size of acknowledgement data (ACK packets) in TCP and QUIC protocols is smaller than that of the request data (HTTP request packets).

Therefore, the request data (HTTP request packets) and the acknowledgement data (ACK packets) can be distinguished based on the data size. In the case of ABR video data, the request data includes information such as image quality and segments of the video data to be obtained. Therefore, the data size of one request data is at least several hundred bytes or more. On the other hand, the acknowledgement data does not include complex information, and the data size of the acknowledgement data is much smaller than that of the request data (about 100 bytes).

Therefore, the data relay apparatus 30A according to the present disclosure determines whether the uploaded data is the request data or the acknowledgement data based on the data size of the uploaded data transmitted from the CL10 to the OS20. This method can be applied regardless of whether the uploaded data is encrypted or not.

The data relay apparatus 30A judges the request data according to the method described above, and determines whether or not accelerated playback is being performed in the CL10 according to the transmission intervals at which the request data is transmitted from the CL10 to the OS20.

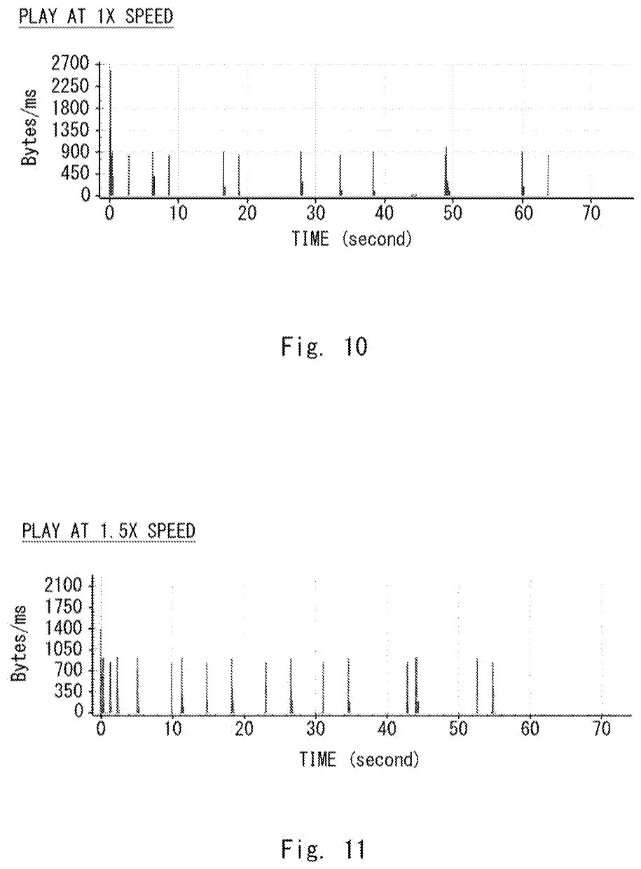

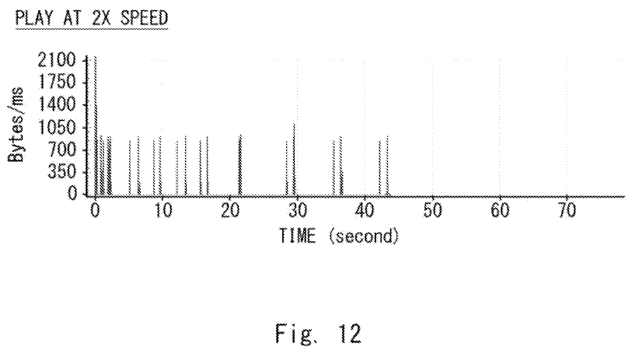

FIGS. 10 to 12 show graphs in which the request data from the CL10 is observed when the same video data of the same image quality is played at different playback speeds in the CL10. In FIGS. 10 to 12, the horizontal axes represent time, and the vertical axes represent the data size of the request data. Furthermore, FIG. 10 shows the request data during playback at 1× speed, FIG. 11 shows the request data during playback at 1.5× speed, and FIG. 12 shows the request data during playback at 2× speed.

As shown in FIGS. 10 to 12, the transmission intervals of the request data from the CL10 is longest during playback at 1× speed (FIG. 10) and shortest during playback at 2× speed (FIG. 12). From this, it is understood that the faster the playback speed is, the shorter the transmission intervals of the request data from the CL10 are.

Therefore, the data relay apparatus 30A determines whether or not accelerated playback is being performed in the CL10 based on the transmission intervals of request data from the CL10.

Example embodiments of the present disclosure will be described below.

### First Example Embodiment

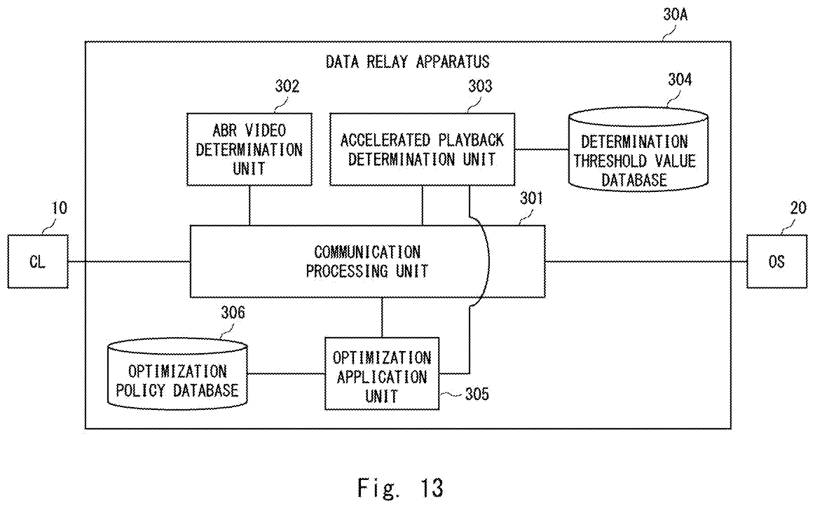

FIG. 13 shows a configuration example of a data relay apparatus 30A according to a first example embodiment. As shown in FIG. 13, the data relay apparatus 30A according to the first example embodiment is arranged between CL (Client) 10 and OS (Origin Server) 20. The CL10, the OS20, and the data relay apparatus 30A shown in FIG. 13 constitute a distribution system.

The CL10 and the data relay apparatus 30A and the data relay apparatus 30A and the OS20 are connected by different networks. Typically, the CL10 and the data relay apparatus 30A are connected by a wireless network, and the data relay apparatus 30A and the OS20 are connected by a wired network. However, the network combination is not limited thereto, and any other combination may be used.

The CL10 is a client terminal which requests that the OS20 transmit video data and receives video data to be distributed as a response to the request. Specific examples of the CL10 include a mobile phone including a smartphone, a tablet terminal, a personal computer, and a television with a network connection function. The OS20 is a distribution server that distributes video data as a response to a request from the CL10.

The data relay apparatus 30A according to the first example embodiment is a device that relays communication between the CL10 and the OS20 and applies traffic optimization processing. The data relay apparatus 30A according to the first example embodiment includes a communication processing unit 301, an ABR video determination unit 302, an accelerated playback determination unit 303, a determination threshold value database 304, an optimization application unit 305, and an optimization policy database 306.

The communication processing unit 301 relays communication in the data relay apparatus 30A. When the data relay apparatus 30A terminates TCP/UDP communication, the communication processing unit 301 corresponds to an application that operates as a proxy (proxy server) to the OS20.

Based on the uploaded data from the CL10 and the response data from the OS20, the ABR video determination unit 302 determines whether the communication between the CL10 and the OS20 is a communication related to the distribution of ABR video data. For example, the ABR video determination unit 302 determines whether or not the communication is a communication related to the distribution of the ABR video data based on the IP address information included in the header information and the data size information. However, the determination method is not limited thereto.

The accelerated playback determination unit 303 observes the uploaded data transmitted from the CL10 to the OS20, and determines whether or not accelerated playback of the video data is being performed in the CL10 based on the data size of the uploaded data and the transmission intervals. Specifically, the accelerated playback determination unit 303 determines whether or not the uploaded data is the request data based on the data size of the uploaded data, and further determines whether or not accelerated playback is performed based on the transmission intervals of the request data.

Details of the operation of the accelerated playback determination unit 303 are as follows. That is, the accelerated playback determination unit 303 observes the communication determined by the ABR video determination unit 302 as the communication related to the distribution of the ABR video data. The accelerated playback determination unit 303 determines whether the uploaded data is the request data or not based on the data size of the uploaded data transmitted from the CL10 to the OS20.

The transmission intervals of the request data from the CL10 at the time of accelerated playback differ for each OS20. Therefore, the accelerated playback determination unit 303 provides the information on the OS20 to the determination threshold value database 304 as key information, and obtains the threshold value of the transmission intervals of the request data for determining accelerated playback for the OS20. Then, the accelerated playback determination unit 303 determines whether or not accelerated playback is being performed in the CL10 by comparing the transmission intervals of the request data from the CL10 with the threshold value obtained from the determination threshold value database 304, and when it is determined that accelerated playback is being performed, it also determines the playback speed of the accelerated playback. Note that the accelerated playback determination unit 303 may obtain a plurality of threshold values for the OS20 from the determination threshold value database 304, and determine whether or not accelerated playback is being performed in the CL10 or determine the playback speed based on which range of the plurality of ranges divided by the plurality of threshold values the transmission intervals of the request data from the CL10 belong to.

When the accelerated playback determination unit 303 determines that accelerated playback is being performed in the CL10, the accelerated playback determination unit 303 notifies the optimization application unit 305 of the playback speed of the accelerated playback.

As described above, the transmission intervals of the request data from the CL10 during accelerated playback differ for each OS20. Therefore, the determination threshold value database 304 stores a threshold value of the transmission intervals of the request data for determining accelerated playback for each OS20. When the determination threshold value database 304 receives an inquiry from the accelerated playback determination unit 303, the determination threshold value database 304 receives the information on the OS20 as key information and returns the threshold value for the OS20. The determination threshold value database 304 may store a plurality of threshold values for each OS20 and return the plurality of threshold values for the OS20 in response to an inquiry from the accelerated playback determination unit 303.

The optimization application unit 305 receives video data from a communication processing unit 301 as response data from the OS20, and performs traffic optimization processing for controlling a transmission bitrate on the video data.

Details of the operation of the optimization application unit 305 are as follows. That is, the optimization application unit 305 provides the information on the communication between the CL10 and the OS20 (such as the IP address of the CL10 and the OS20) as key information to the optimization policy database 306, and inquires as to which optimization policy is to be applied to the communication. When the optimization application unit 305 receives the notification of the playback speed of the accelerated playback from the accelerated playback determination unit 303, the optimization application unit 305 provides to the optimization policy database 306 information on the playback speed of the accelerated playback together with the communication information described above as key information, and inquires as to which optimization policy is to be applied.

The optimization application unit 305 obtains the optimization policy from the optimization policy database 306 as a result of the inquiry. The optimization policy also includes the information about the transmission bitrate of the ABR video data. The optimization application unit 305 performs traffic optimization processing of video data based on the optimization policy obtained from the optimization policy database 306.

The optimization policy database 306 determines the optimization policy to be applied to the communication (such as the IP address of the CL10 and the OS20) in response to the inquiry containing the information on the communication between the CL10 and the OS20 from the optimization application unit 305, and returns the determined optimization policy to the optimization application unit 305. Furthermore, when the optimization application unit 305 has received a notification of the playback speed of the accelerated playback from the accelerated playback decision unit 303, the optimization policy database 306 determines an optimization policy to be applied to the communication in response to the query containing the information on the communication described above from the optimization application unit 305 and the playback speed of the accelerated playback, and returns the determined optimization policy to the optimization application unit 305.

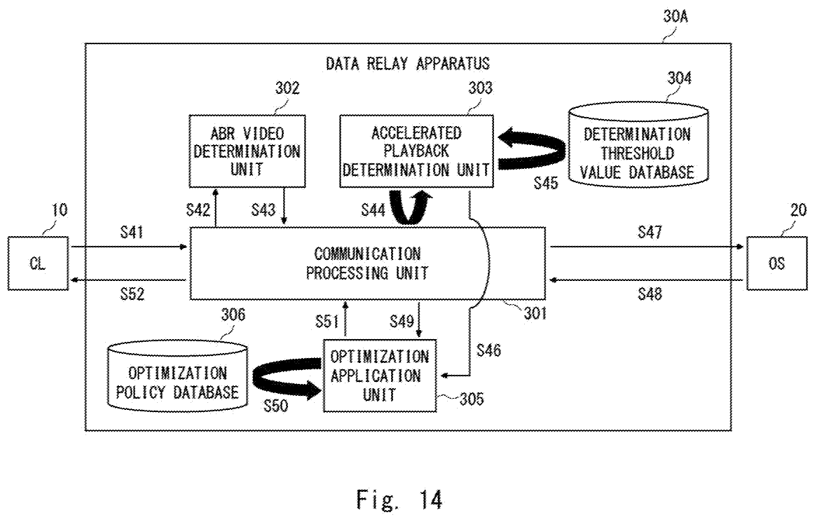

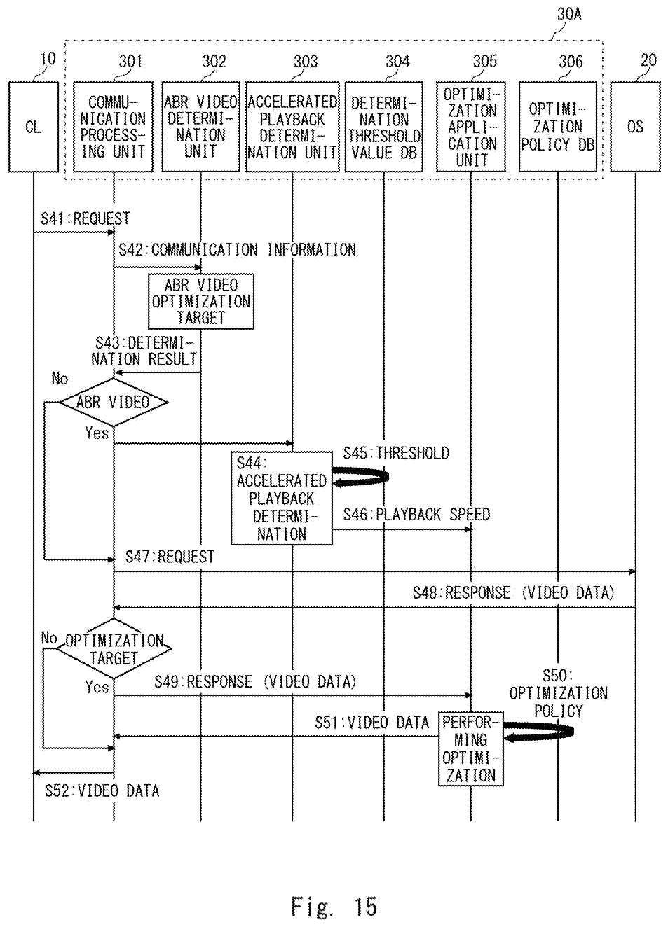

FIGS. 14 and 15 show diagrams for explaining an operation example of the data relay apparatus 30A according to the first example embodiment. In FIGS. 14 and 15, the same steps have the same reference numerals.

As shown in FIGS. 14 and 15, when the communication processing unit 301 receives video data request data (HTTP request packet) from the CL10 (Step S41), the communication processing unit 301 provides the information (such as the IP address of the CL10 and the OS20) of the communication between the CL10 and the OS20 to the ABR video determination unit 302 (Step S42).

Based on the communication information received from the communication processing unit 301, the ABR video determination unit 302 determines whether or not the communication between the CL10 and the OS20 is a communication related to the distribution of the ABR video data (Step S43).

For example, when the ABR video determination unit 302 specifies that the destination of the request data is the OS based on the destination IP address included in the header information on the request data, the ABR video determination unit 302 may determine that the communication is related to the distribution of the ABR video data. Furthermore, when the ABR video determination unit 302 determines that the communication is related to the distribution of the ABR video data, the ABR video determination unit 302 determines that the response data (video data) transmitted from the OS20 to the CL10 is the target of traffic optimization.

The ABR video determination unit 302 may perform a similar determination when the ABR video determination unit 302 receives not only the uploaded data from the CL10 but also the response data (video data) from the OS20 in Step S48 described later. For example, when the ABR video determination unit 302 specifies that the source of the response data is the OS based on the source IP address included in the header information on the response data, the ABR video determination unit 302 may determine that the communication is related to the distribution of the ABR video data.

The ABR video determination unit 302 returns to the communication processing unit 301 the determination result of whether or not the communication between the CL10 and the OS20 is related to the distribution of the ABR video data (Step S43). Furthermore, when the ABR video determination unit 302 determines that the communication is related to the distribution of the ABR video data, the ABR video determination unit 302 also notifies the communication processing unit 301 that the response data (video data) transmitted from the OS20 to the CL10 is the target of traffic optimization.

Here, when the ABR video determination unit 302 determines that the communication is related to the distribution of the ABR video data, the communication processing unit 301 activates the accelerated playback determination unit 303 (Step S44).

The accelerated playback determination unit 303 provides the information on the OS20 to the determination threshold value database 304 as key information, and obtains a threshold value of the transmission intervals of the request data for determining accelerated playback for the OS20 (Step S45).

In addition, the accelerated playback determination unit 303 observes the communication determined to be the communication related to the distribution of the ABR video data by the ABR video determination unit 302, and determines whether or not the uploaded data is the request data based on the data size of the uploaded data. When the accelerated playback determination unit 303 determines that the uploaded data is the request data, the accelerated playback determination unit 303 compares the transmission intervals of the request data with the threshold value obtained from the determination threshold value database 304 in Step S45 to determine whether or not accelerated playback is being performed in the CL10, and when it is determined that accelerated playback is being performed, the playback speed of accelerated playback is also determined.

When the accelerated playback determination unit 303 determines that accelerated playback is being performed in the CL10, the accelerated playback determination unit 303 notifies the optimization application unit 305 of the playback speed of accelerated playback (Step S46).

The communication processing unit 301 transfers the request data from the CL10 to the OS20 (Step S47). Note that when the ABR video determination unit 302 determines that the communication is not a communication related to the distribution of the ABR video data, the communication processing unit 301 transfers the request data from the CL10 to the OS20 without activating the accelerated playback determination unit 303 (Step S47).

The communication processing unit 301 receives response data (video data) corresponding to the request data of the CL10 from the OS20 (Step S48).

Here, when the ABR video determination unit 302 determines that the response data (video data) from the OS20 is the target of traffic optimization, the communication processing unit 301 provides the response data (video data) to the optimization application unit 305 (Step S49).

The optimization application unit 305 provides the information (such as the IP address of the CL10 and the OS20) of the communication between the CL10 and the OS20 as key information to the optimization policy database 306, and inquires as to which optimization policy is to be applied to the communication. Furthermore, when the optimization application unit 305 has received the notification of the playback speed of the accelerated playback from the accelerated playback determination unit 303, the optimization application unit 305 provides the information on the playback speed of the accelerated playback together with the information on the communication described above as key information to the optimization policy database 306, and inquires as to which optimization policy is to be applied.

The optimization policy database 306 determines the optimization policy to be applied to the communication between the CL10 and the OS20 in response to the inquiry from the optimization application unit 305, and returns the determined optimization policy to the optimization application unit 305 (Step S50). The optimization policy also includes information on the transmission bitrate of the response data (video data).

Based on the optimization policy acquired from the optimization policy database 306, the optimization application unit 305 performs traffic optimization processing for controlling the transmission bitrate on the response data (video data), and returns the video data subjected to traffic optimization processing to the communication processing unit 301 (Step S51).

The communication processing unit 301 transmits the video data returned from the optimization application unit 305 to the CL10 (Step S52). If the ABR video determination unit 302 determines that the response data (video data) from the OS20 is not the target of traffic optimization, the communication processing unit 301 transmits the response data (video data) to the CL10 without transmitting it to the optimization application unit 305 (Step S52).

If it is determined in the steps S44 and S45 that accelerated playback is being performed in the CL10 while the Steps S41 to S52 are repeated, the accelerated playback determination unit 303 notifies the optimization application unit 305 of the playback speed of the accelerated playback (Step S46). In response to this, the optimization application unit 305 performs traffic optimization processing based on the optimization policy for accelerated playback (Step S50).

According to the first example embodiment, the data relay apparatus 30A determines whether or not the uploaded data is request data based on the data size of the uploaded data transmitted from the CL10 to the OS20, and further determines whether or not accelerated playback of video data is being performed in the CL10 based on the transmission intervals of the request data.

Here, the data size and the transmission intervals of the uploaded data are information that can also be obtained by the data relay apparatus 30A. Therefore, the data relay apparatus 30A can determine from the information that can be obtained by the data relay apparatus 30A whether or not the video data is being played using accelerated playback in the CL10.

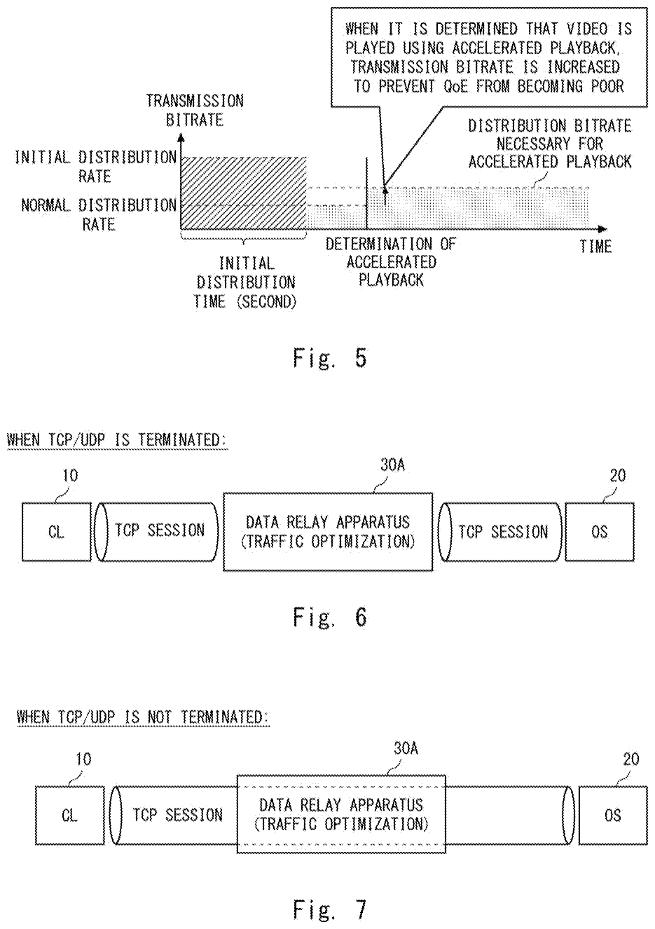

The data relay apparatus 30A can also determine whether the video data is being played using accelerated playback in the CL10, so that when the data relay apparatus 30A determines that the video data is being played using accelerated playback in the CL10, it can perform traffic optimization processing such as, for example, increasing the transmission bitrate of the video data to be transmitted to the CL10 as shown in FIG. 5. Thus, the CL10 can optimize traffic and prevent QoE from becoming poor during the playback of the video data using accelerated playback.

### Second Example Embodiment

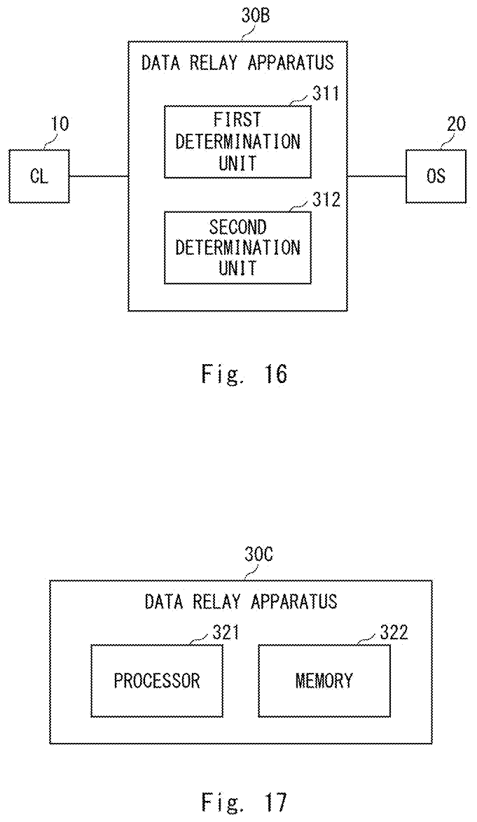

FIG. 16 shows a configuration example of a data relay apparatus 30B according to a second example embodiment. Note that the second example embodiment corresponds to the example embodiment in which the first example embodiment described above is conceptualized in a higher level.

As shown in FIG. 16, the data relay apparatus 30B according to the second example embodiment is arranged between a CL (client terminal) 10 and an OS (distribution server) 20 that distributes the video data, and transmits the video data distributed from the OS20 to the CL10.

The data relay apparatus 30B according to the second example embodiment includes a first determination unit 311 and a second determination unit 312. The first determination unit 311 and the second determination unit 312 correspond to the combination of the communication processing unit 301 and the accelerated playback determination unit 303 according to the first example embodiment described above.

The first determination unit 311 receives the uploaded data transmitted from the CL10 to the OS20 and determines whether or not the uploaded data is the specified upload data based on the data size of the uploaded data.

The second determination unit 312 determines whether or not the video data is being played using accelerated playback in the CL10 based on the transmission interval of the specified uploaded data determined by the first determination unit 311.

According to the second example embodiment, the data relay apparatus 30B determines whether or not the uploaded data is the specified uploaded data based on the data size of the uploaded data transmitted from the CL10 to the OS20, and further determines whether or not the video data is being played using accelerated playback in the CL10 based on the determined transmission intervals of the specified uploaded data.

Here, the data size and the transmission intervals of the uploaded data are information that can also be obtained by the data relay apparatus 30B. Therefore, the data relay apparatus 30B can determine from the information that can be obtained by the data relay apparatus 30B whether or not the video data is being played using accelerated playback in the CL10.

The data relay apparatus 30B according to the second example embodiment may further include a control unit for controlling the transmission bitrate of the video data to be transmitted to the CL10 based on the determination result of the accelerated playback by the second determination unit 312. This control unit corresponds to the combination of the communication processing unit 301 and the optimization application unit 305 according to the first example embodiment described above.

Based on the data size of the uploaded data transmitted from the CL10 to the OS20, the first determination unit 311 may determine whether the uploaded data is request data for requesting video data or acknowledgement data for notifying that video data has been received. The specified uploaded data may be request data.

When the second determination unit 312 determines that accelerated playback of the video data is being performed in the CL10, it may further determine the playback speed of the accelerated playback performed in the CL10 based on the transmission intervals of the request data. Furthermore, the control unit may also control the transmission bitrate of the video data to be transmitted to the CL10 based on the determination result of the playback speed of the accelerated playback by the second determination unit 312.

### Third Example Embodiment

FIG. 17 shows a hardware configuration example of a data relay apparatus 30C according to a third example embodiment. As shown in FIG. 17, the data relay apparatus 30C according to the third example embodiment includes a processor 321 and a memory 322.

The processor 321 may be, for example, a microprocessor, an MPU (Micro Processing Unit), or a CPU (Central Processing Unit). The processor 321 may include a plurality of processors.

The memory 322 consists of a combination of a volatile memory and a nonvolatile memory. The memory 322 may include storage located away from the processor 321. In this case, the processor 321 may access the memory 322 via an I (Input)/O (Output) interface, which is not shown.

The data relay apparatuses 30A and 30B of the first and second example embodiments described above may have the hardware configuration shown in FIG. 17. A program is stored in the memory 322. The program includes an instruction group (or software code) for causing the computer to perform one or more functions of the data relay apparatus 30A or 30B described in the first and second example embodiments above when read into the computer. The communication processing unit 301, the ABR video determination unit 302, the accelerated playback determination unit 303, the optimization application unit 305, the first determination unit 311, and the second determination unit 312 of the data relay apparatuses 30A and 30B described above may be implemented by the processor 321 reading and executing the program stored in the memory 322. The determination threshold value database 304 and the optimization policy database 306 of the data relay apparatus 30A described above may be implemented by the memory 322.

The program described above may also be stored in a non-temporary computer-readable medium or a tangible storage medium. By way of example, but not limitation, a computer-readable medium or a tangible storage medium may include random-access memory (RAM), read-only memory (ROM), flash memory, solid-state drive (SSD) or other memory technology, CD-ROM, digital versatile disc (DVD), Blu-ray (Trademark) disc or other optical disc storage, magnetic cassette, magnetic tape, magnetic disc storage or other magnetic storage device. The program may be transmitted on a temporary computer-readable medium or communication medium. By way of example, but not limitation, a temporary computer-readable medium or communication medium may include an electrical, optical, acoustic, or other form of propagating signal.

Although the present disclosure has been described with reference to the example embodiments, the present disclosure is not limited to the example embodiments described above. Various changes in the configurations and details of the present disclosure may be made within the scope of the present disclosure that may be understood by those skilled in the art.

In addition, although the industrial applicability of the present disclosure is clear from the above description, the present disclosure may be used, for example, for communication flow control for TCP/UDP communication between the CL and the OS in mobile communications (cellular networks).

Furthermore, the present disclosure can also be used for communication flow control for TCP/UDP communication through various access networks such as wireless LAN (Local Area Network), wired LAN, optical fiber, etc., instead of a cellular network.

### REFERENCE SIGNS LIST

10: CL (CLIENT TERMINAL)
20: OS (DISTRIBUTION SERVER)
30, 30A, 30B, 30C: DATA RELAY APPARATUS
301: COMMUNICATION PROCESSING UNIT
302: ABR VIDEO DETERMINATION UNIT
303: ACCELERATED PLAYBACK DETERMINATION UNIT
304: DETERMINATION THRESHOLD VALUE DATABASE
305: OPTIMIZATION APPLICATION UNIT
306: OPTIMIZATION POLICY DATABASE
311: FIRST DETERMINATION UNIT
312: SECOND DETERMINATION UNIT
321: PROCESSOR
322: MEMORY

What is claimed is:

1. A data relay apparatus arranged between a client terminal and a distribution server for distributing video data and configured to transmit the video data distributed from the distribution server to the client terminal, comprising:
at least one memory storing instructions, and
at least one processor configured to execute the instructions to;
receive uploaded data to be transmitted from the client terminal to the distribution server and determine whether or not the uploaded data is specified uploaded data based on a data size of the uploaded data; and
determine whether or not accelerated playback of the video data is being performed at the client terminal based on a transmission interval of the determined specified uploaded data.

2. The data relay apparatus according to claim 1, wherein
the at least one processor is further configured to execute the instructions to a control a transmission bitrate of the video data to be transmitted to the client terminal based on a result of the determination in regard to the accelerated playback.

3. The data relay apparatus according to claim 2, wherein
the at least one processor is further configured to execute the instructions to determine whether the uploaded data is request data for requesting the video data or acknowledgement data for notifying that the video data has been received based on the data size of the uploaded data to be transmitted from the client terminal to the distribution server, and
the specified uploaded data is the request data.

4. The data relay apparatus according to claim 3, wherein the at least one processor is further configured to execute the instructions to determine a playback speed of the accelerated playback performed at the client terminal based on a transmission interval of the request data when the second determination unit determines that the accelerated playback of the video data is being performed at the client terminal.

5. The data relay apparatus according to claim 4, wherein the at least one processor is further configured to execute the instructions to control the transmission bitrate of the video data to be transmitted to the client terminal based on the result of the determination in regard to the playback speed of the accelerated playback.

6. A distribution system comprising:
a client terminal;
a distribution server configured to distribute video data; and
a data relay apparatus according to claim 1.

7. A data relay method performed by a data relay apparatus arranged between a client terminal and a distribution server for distributing video data and configured to transmit video data distributed from the distribution server to the client terminal, comprising:
a receiving step of receiving uploaded data to be transmitted from the client terminal to the distribution server;
a first determination step of determining whether or not the uploaded data is specified uploaded data based on a data size of the uploaded data; and
a second determination step of determining whether or not accelerated playback of the video data is being performed at the client terminal based on a transmission interval of the determined specified uploaded data.

8. A non-temporary computer-readable medium storing a program for causing a computer, which is arranged between a client terminal and a distribution server for distributing video data and configured to transmit video data distributed from the distribution server to the client terminal, to execute:
a receiving process for receiving uploaded data to be transmitted from the client terminal to the distribution server;
a first determination process for determining whether or not the uploaded data is specified uploaded data based on a data size of the uploaded data; and
a second determination process for determining whether or not accelerated playback of the video data is being performed at the client terminal based on a transmission interval of the determined specified uploaded data.
